(19) United States
(12) Patent Application Publication
(10) Pub. No.: US 2012/0001856 A1
(43) Pub. Date: Jan. 5, 2012

(54) RESPONDING TO TACTILE INPUTS

(75) Inventor: Brian Davidson, Surrey (GB)

(73) Assignee: Nokia Corporation

(21) Appl. No.: 12/829,899

(22) Filed: Jul. 2, 2010

(51) Int. Cl. G06F 3/041

(52) U.S. Cl. 345/173

(57) ABSTRACT

Apparatus comprises at least one processor, and at least one memory including computer program code, where the at least one memory and the computer program code are configured, with the at least one processor, to cause the apparatus to at least, during a communication session with remote apparatus to cause to be displayed on a display a first image received from the remote apparatus as part of the communication session, and to be responsive to receipt of a signal indicative of an incidence of a touch input at a location on the display at which the image is displayed to cause to be transmitted to a remote terminal associated with the first image a signal for causing an alert to be output by the remote terminal.

### FIELD

This invention relates to responding to tactile inputs.

### BACKGROUND

It is known for users of computing apparatus to interact with one another via networks such as the Internet.

### SUMMARY

According to a first aspect, this specification describes apparatus comprising at least one processor, and at least one memory including computer program code, where the at least one memory and the computer program code are configured, with the at least one processor, to cause the apparatus at least, during a communication session with remote apparatus to cause to be displayed on a display a first image received from the remote apparatus as part of the communication session, and to be responsive to receipt of a signal indicative of an incidence of a touch input at a location on the display at which the image is displayed to cause to be transmitted to a remote terminal associated with the first image a signal for causing an alert to be output by the remote terminal.

The at least one memory and the computer program code may be configured, with the at least one processor, to cause the apparatus to be responsive to receipt from the remote terminal of a signal for causing an alert to be output to cause an audible alert to be output by a loudspeaker.

The apparatus may comprise the display and a transducer for detecting the incidence of a touch input on the display. The apparatus may be a mobile terminal.

According to a second aspect, this specification describes a method comprising, during a communication session with remote apparatus, causing to be displayed on a display a first image received from the remote apparatus as part of the communication session, and responding to receipt of a signal indicative of an incidence of a touch input at a location on the display at which the image is displayed by causing to be transmitted to a remote terminal associated with the first image a signal for causing an alert to be output by the remote terminal.

The method may comprise responding to receipt from the remote terminal of a signal for causing an alert to be output by causing an audible alert to be output by a loudspeaker.

The method may comprise the remote terminal responding to receipt of the signal for causing the alert to be output by causing an audible alert to be output by a loudspeaker.

The signal for causing the alert to be output may include information indicative of a force of the touch input, and the method may comprise the remote terminal selecting an output volume for the alert based on the force information. The signal for causing the alert to be output may include information indicative of a gesture type of the touch input, and the method may comprise the remote terminal to selecting a type of the alert based on the gesture type information.

According to a third aspect, this specification describes computer-readable instructions, which when executed by computing apparatus, cause the computing apparatus to perform a method according to the second aspect.

According to a fourth aspect, this specification describes a non-transitory computer-readable storage medium having stored thereon computer-readable code, which, when executed by computing apparatus, causes the computing apparatus, during a communication session with remote apparatus: to cause to be displayed on a display a first image received from the remote apparatus as part of the communication session; and to be responsive to receipt of a signal indicative of an incidence of a touch input at a location on the display at which the image is displayed to cause to be transmitted to a remote terminal associated with the first image a signal for causing an alert to be output by the remote terminal.

The computer-readable code may, when executed by computing apparatus cause the computing apparatus, subsequent to causing transmittal to the remote terminal of the signal, to cause a two-way audio connection with the remote terminal to be established.

The remote terminal may comprise the remote apparatus, the communication session may be a video communication session, and the first image may be a portion of an incoming video stream. The video communication session comprises a two-way video communication session, and the computer-readable code may, when executed by computing apparatus cause the computing apparatus to cause an outgoing video stream to be transmitted to the remote terminal.

The computer-readable code may, when executed by computing apparatus cause the computing apparatus to receive a signal indicative of a gesture type of the touch input and to cause the signal for causing an alert to be output by the remote terminal to contain information indicative of the gesture type of the touch input.

The computer-readable code may, when executed by computing apparatus cause the computing apparatus to receive a signal indicative of a force of the touch input and to cause the signal for causing an alert to be output by the remote terminal to contain information indicative of the force of the touch input.

The remote apparatus may be a server and the computer-readable code may, when executed by computing apparatus cause the computing apparatus to cause the signal for causing an alert to be output by the remote terminal to be transmitted to the remote terminal via the server. The computer-readable code may, when executed by computing apparatus cause the computing apparatus, subsequent to causing transmittal to the remote terminal of the signal, to cause a two-way audio-visual connection with the remote terminal to be established.

The computer-readable code may, when executed by computing apparatus cause the computing apparatus to be responsive to receipt from the remote terminal of a signal for causing an alert to be output to cause an audible alert to be output by a loudspeaker.

According to a fifth aspect, this specification describes apparatus comprising means for causing, during a communication session with remote apparatus, to be displayed on a display a first image received from the remote apparatus as part of the communication session, and means for responding to receipt of a signal indicative of an incidence of a touch input at a location on the display at which the image is displayed by causing to be transmitted to a remote terminal associated with the first image a signal for causing an alert to be output by the remote terminal.

The apparatus may comprise means for, subsequent to causing transmittal to the remote terminal of the signal, causing a two-way audio connection with the remote terminal to be established.

The remote terminal comprises the remote apparatus the communication session may be a video communication session, and the first image may be a portion of an incoming video stream. The video communication session may comprise a two-way video communication session, and the apparatus may comprise means for causing an outgoing video stream to be transmitted to the remote terminal.

The apparatus may comprise means for receiving a signal indicative of a gesture type of the touch input and means for causing the signal for causing an alert to be output by the remote terminal to contain information indicative of the gesture type of the touch input.

The apparatus may comprise means for receiving a signal indicative of a force of the touch input and means for causing the signal for causing an alert to be output by the remote terminal to contain information indicative of the force of the touch input.

The apparatus may comprise means for causing the signal for causing an alert to be output by the remote terminal to be transmitted to the remote terminal via the server. The apparatus may comprise means for causing, subsequent to causing transmittal to the remote terminal of the signal, a two-way audio-visual connection with the remote terminal to be established.

The apparatus may comprise means for responding to receipt from the remote terminal of a signal for causing an alert to be output by causing an audible alert to be output by a loudspeaker.

### BRIEF DESCRIPTION OF THE DRAWINGS

For a more complete understanding of example embodiments of the present invention, reference is now made to the following description taken in connection with the accompanying drawings in which:

FIG. 1 is a schematic overview of a communication system in which example embodiments of the present invention are implemented;

FIG. 2 is a schematic overview of communication apparatus according to example embodiments of the present invention;

FIGS. 3A to 3C depicts a simplified overview of an operation according to a first example embodiment of the invention;

FIGS. 4A and 4B are flow diagrams depicting operations of first and second communication apparatuses respectively according to the first example embodiment of the invention;

FIGS. 5A to 5C are a simplified overview of an operation according to a second example embodiment of the invention;

FIGS. 6A and 6B are flow diagrams depicting operations of first and second communication apparatuses respectively according to the second example embodiment of the invention;

### DETAILED DESCRIPTION OF THE EMBODIMENTS

In the description and drawings, like reference numerals refer to like elements throughout.

FIG. 1 is a simplified schematic overview of a communication system 1 in which example embodiments of the invention are implemented. The communication system 1 comprises a first communication apparatus 10 and a second communication apparatus 20 which are operable to communication with one another via a network 30. The first and second communication apparatus 10, 20 may communicate with the network 30 separately via a wireless connection, a wired connection, or a combination of wired and wireless connections.

The first communication apparatus 10 comprises a first terminal 11 and a first transceiver 12. The second communication apparatus 20 comprises a second terminal 21 and a second transceiver 22. Each of the first and second transceivers 12, 22 are operable to send signals to and to receive signals from the network 30.

The network 30 comprises a packet-switched network such as the Internet. Alternatively, the network 30 may comprise any other suitable type of network. The network is operable to route signals received from the first communication apparatus 10 to the second communication apparatus 20 and vice versa, thereby allowing the first and second communication apparatuses 10, 20 to communicate with one another. The network 30 is operable also to route signals received from either of the first and second communication apparatuses 10, 20 to a server apparatus 31. Similarly, the network 30 may able to route signals received from the server apparatus 31 to either of the first and second communication apparatuses 10, 20. Thus, the network 30 is operable to allow the first and second communication apparatuses 10, 20 to communicate with the server apparatus 31 and to communicate with one another via the server apparatus 31. The server apparatus 31 is operable to provide services to one or more subscribers such as users of the first and second communication apparatuses 10, 20. The server apparatus 31 may have an associated store 31A for storing information relating to the one or more subscribers such as the users of the first and second communication apparatuses 10, 20.

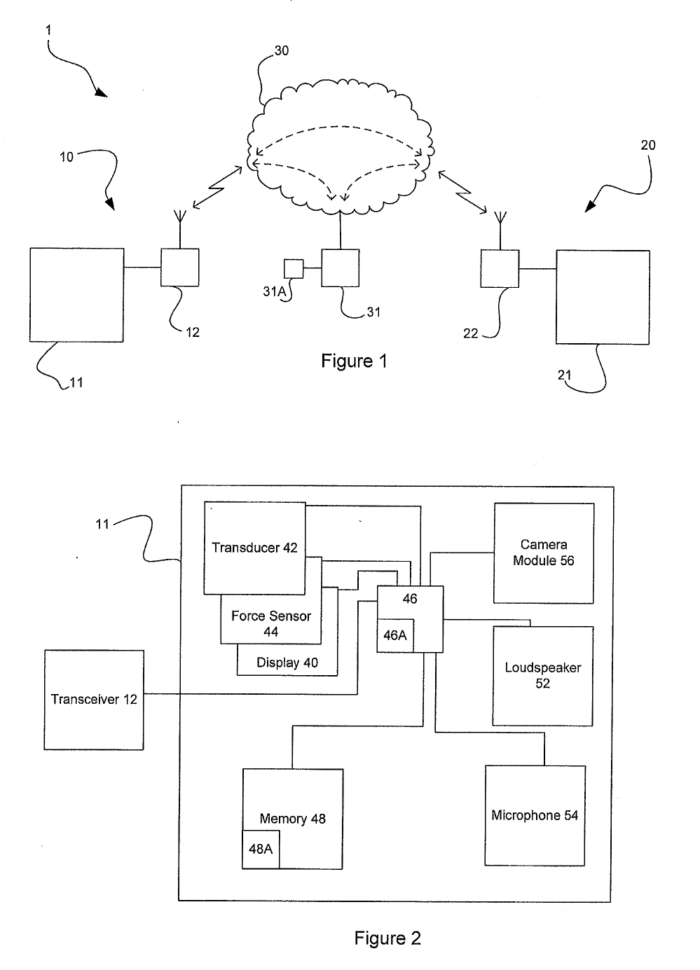

FIG. 2 is a schematic overview of the first communication apparatus 10. It will be understood, however, that the second communication apparatus 20 may be comprised similarly to the first communication apparatus 10 as described below with reference to FIG. 2.

The communication apparatus 10 may comprise a single physical entity or may comprise a plurality of separate entities. The first communication apparatus 10 comprises the first terminal 11 and the first transceiver 12. In FIGS. 1 and 2, the first terminal 11 and the first transceiver 12 are depicted as separate entities. However, it will be understood that the first transceiver 12 may be part of the first terminal 11, and thus the first communication apparatus may comprise a single entity.

The communication apparatus may be, but is not limited to, any of a personal computer (PC), such as a laptop, a netbook or a desktop, a mobile telephone, a smartphone, a personal digital assistant, and a wall or desk mounted display panel.

The first transceiver 12 is operable to receive signals from the network 30 and to pass these received signals to the first terminal 11. The first transceiver 12 is operable also to receive signals from the first terminal 11 and transmit these to the network 30. The signals transmitted and received include many different types of signals including, but not limited to, audio signals, video signals, audio visual signals and command signals.

The first terminal 11 comprises a display panel 40. The display panel 40 is operable to display images received from the network 30 via the first transceiver 12 for consumption by the user of the first terminal 11. The first terminal 11 also comprises a touch-sensitive transducer 42 overlaid on the display panel 40. The combination of the display panel 40 and the touch-sensitive transducer 42 forms a touchscreen 40, 42. The touch-sensitive transducer 42 is operable to detect incidences of user touch inputs on the surface of the touchscreen 40, 42. The display panel 40 may be any suitable type of display panel such as, but not limited to, an LED display panel, a plasma display panel and an OLED display panel. The touch-sensitive transducer 42 may be any suitable type of touch-sensitive transducer, for example, but not limited to, a resistive touch-sensitive transducer, a surface acoustic wave touch-sensitive transducer and a capacitive touch-sensitive transducer.

The first terminal 11 also comprises a controller 46. The controller 46 includes one or more processors 46A. The one or more processors 46A operate under the control of computer-readable code 48A, particularly an operating system and additional software, middleware or firmware modules, and software applications. The computer-readable code 48A is stored in a memory 48. The controller 46 may also comprise one or more application specific integrated circuits (ASICs) (not shown). The memory 48 may comprise one or more non-transitory memory media, such as but not limited to ROM and RAM.

The controller 46 is operable under the control of the computer-readable code 48A to control the output of the display panel 40. The controller 46 is also operable to receive from the touch-sensitive transducer 42 signals indicative of touch inputs incident on the surface of the touchscreen 40, 42. The controller 46 is operable to determine based on the signals indicative of touch inputs the presence of a touch input and also to determine a location of the touch input on the touchscreen 40, 42.

The controller 46 may be operable also to determine, based on the signals received from the touch-sensitive transducer 42, a gesture type of touch inputs applied to the surface of the touchscreen 40, 42. The controller 46 may be able to determine the gesture type, for example, based on determination of the number of simultaneous touch inputs incident on the touchscreen 40, 42, a direction of movement of one or more touch inputs on the touchscreen 40, 42 and a duration for which a touch input is incident on the touchscreen 40, 42. As such, the controller 46 is operable to determine that consecutive touch inputs, each having one or more points of contact with the touchscreen 40, 42, and each having a duration of less then a predetermined period constitutes a “knock input” gesture. In other words, the controller 46 is operable to determine that the user is knocking on the surface of the touchscreen with their knuckles, as they would knock on a door to a residence. Similarly, the controller 46 may be operable to determine that a touch input having one or more points of contacts and which is moved across the surface of the touchscreen 40, 42 constitutes a “scratch input” gesture. In other words, the controller 46 is operable to determine that a user is scratching one or more fingers along the surface of the touchscreen 40, 42. Also, the controller 46 may be operable to determine that a touch input having one or more points of contact, being stationary or mostly stationary and having a duration of longer than a predetermined period comprises a “press input”. In other words, the controller 46 is operable to determine that the user is pressing on the surface of the touchscreen 40, 42. It will be understood that the controller 46 may be operable also to determine other gesture types based on the signals received from the touch-sensitive transducer 40, 42.

The controller 46 is operable also to cause the transceiver to transmit signals via the network to the second communication terminal 21.

The first terminal 11 also comprises a loudspeaker 52 for outputting audio signals for consumption by the user of the first terminal 11. The controller 46 is operable to cause the loudspeaker 52 to output a particular audio signal, based on signals received at the first terminal 11 via the network, for example, from the second communication apparatus 20. The first terminal 11 also comprises a microphone 54 for receiving and capturing audio data from the user of the first terminal 11. The audio data received via the microphone 54 may then be caused by the controller 46 to be transmitted to the network 30 via the first transceiver 12.

According to some example embodiments, the first terminal 11 may comprise a camera module 56 for capturing video data. The camera module 56 may comprise a combination of hardware and software. The captured video data may be caused by the controller 46 to be transmitted to the network 30 via the first transceiver 12.

According to some example embodiments, the first terminal 11 may comprise a force sensor 44 in communication with the touchscreen 40, 42. The force sensor is operable to output signals to the controller 46 indicative of a force of a touch input applied to the touchscreen 40, 42. Based on these signals the controller 46 is operable to determine a force of the touch input incident on a surface of the touchscreen 40, 42.

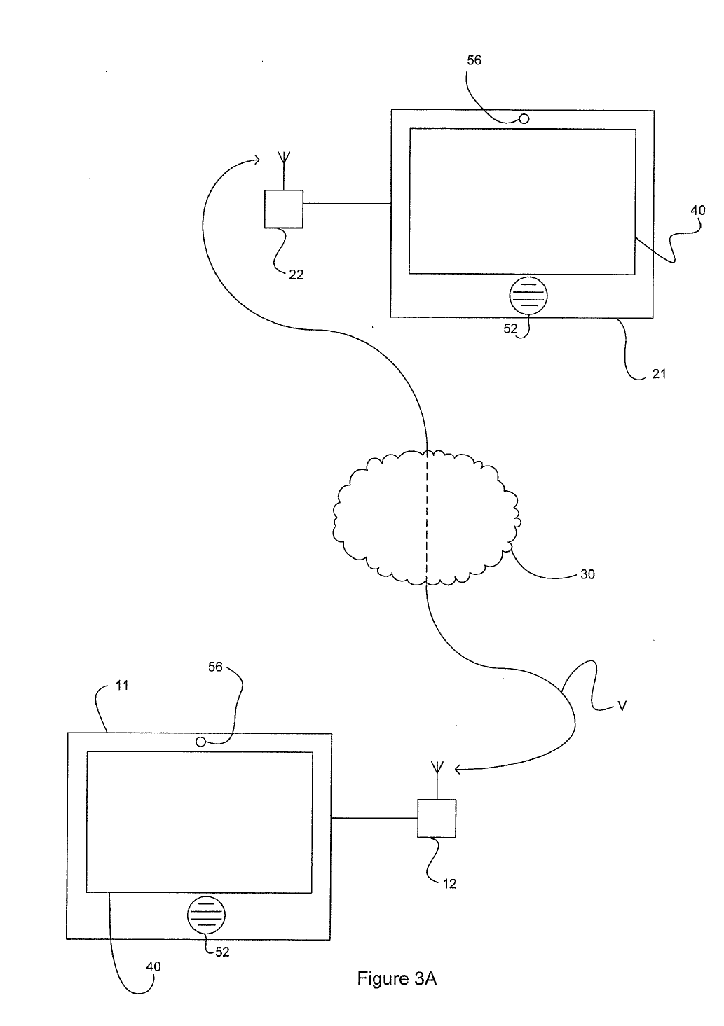

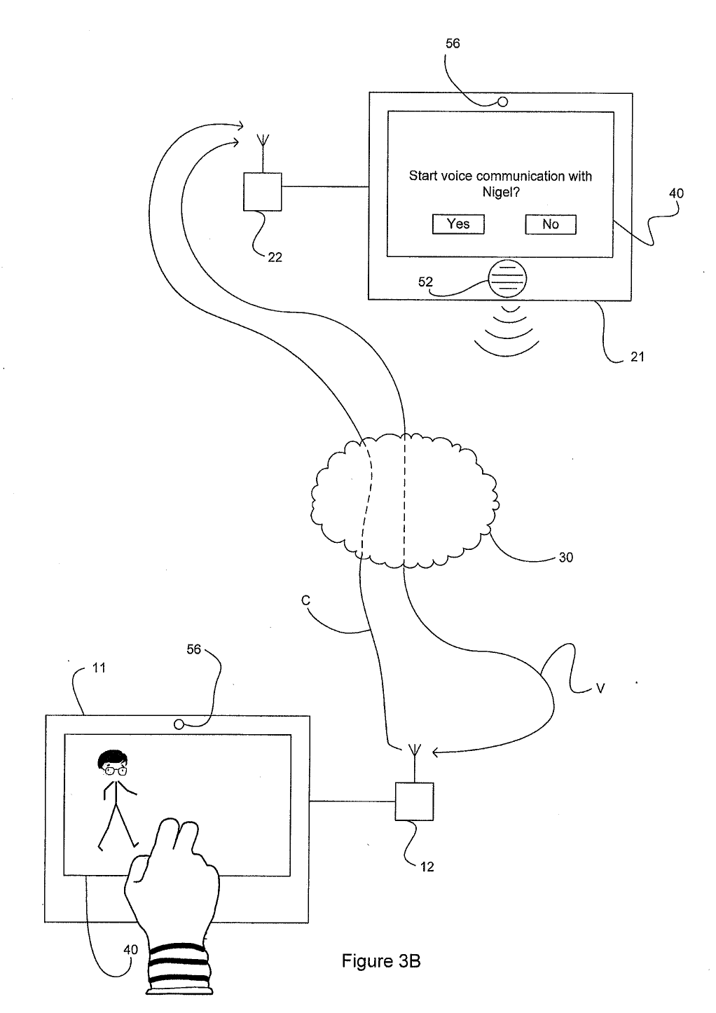

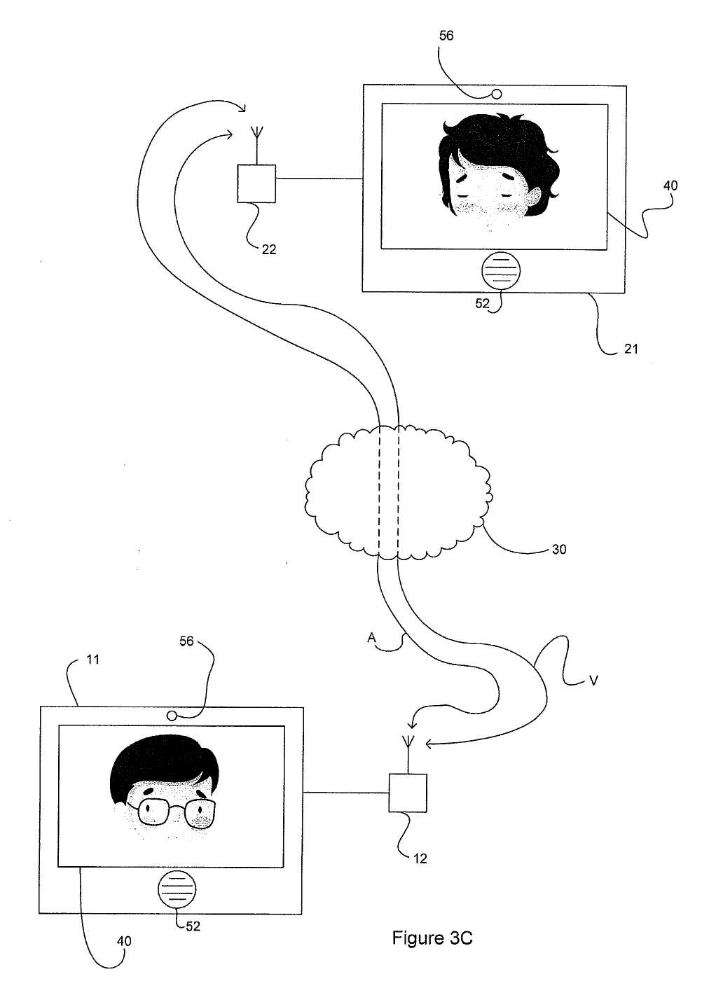

FIGS. 3A to 3C depict an operation according to the first example embodiment of the invention. In the below, the same components of the first and second terminals 11, 21 are denoted by the same reference numerals.

In the first example embodiment, in FIG. 3A the first terminal 11 is capturing video data via its camera module 56. The controller 46 is causing the video data to be transmitted as a first video stream to the second terminal 21. Similarly, the second terminal 21 is capturing video data via its camera module 56 and the controller 46 is causing the video data to be transmitted as a second video stream to the first communication apparatus 20. The first video stream is transmitted via the first transceiver 12 and the network 30 to the second terminal 21 and is caused by the controller to be displayed on the display panel 40 of the second terminal 21. Likewise, the second video stream is captured is transmitted and is caused by the controller 46 to be displayed on the display panel 40 of the first terminal 11. As such, there is a two-way video connection between the first and second terminals 11, 21.

The first video stream, which is displayed on the display 40 of the second terminal 21, depicts the scene in front of the first terminal. The second video stream, which is displayed on the display 40 of the first terminal 11, depicts the scene in front of the second terminal 21. Thus, the terminals may be termed “virtual windows” as they provide a two-way depiction of the environments in front of the first and second terminals 11, 21. The first and second terminals 11, 21 may be, for example, mounted on walls in the home of their respective users. Thus, the user of the first terminal 11 is able to “see into” the home of the user of the second terminal 21 and the user of the second terminal 21 is able to “see into” the home of the user of the first terminal 11.

Next, as seen in FIG. 3B, the user of the second terminal 21 arrives into view on the display 40 of the first terminal 11. The first user, deciding that they wish to initiate audio connection with the second user, applies a touch input to the surface of the touchscreen 40, 42 of the first terminal 11. The incidence of the touch input is detected by the controller 46. In response to the this detection, the controller 46 of the first terminal 11 causes a command signal, denoted by the letter “C” in FIG. 3B, to be sent via the transceiver and the network to the second terminal 21.

Upon receipt of the command signal, the controller 46 of the second terminal 21 causes an audible alert to the output by the loudspeaker 52 of the second terminal 21. The alert causes the user of the second terminal 21 to look in the direction of the second terminal 21 and thus be able to see the presence of the user of the first terminal and to determine that the user of the first terminal 21 wishes to initiate audio connection with them.

Subsequent or simultaneous to outputting the alert, the second terminal 21 provides an option to the second user as to whether they wish to initiate an audio connection with the first terminal 11. In FIG. 3B providing this option comprises text being displayed on the screen along with selectable options; one for “yes” and the other for “no”. Thus if the second user wishes to initiate an audio connection with the first terminal 11 they select the “yes” option and, conversely, if they do not wish to initiate an audio connection with the first terminal 11 they select the “no” option. It will be appreciated that the user may select the “yes” or “no” options in any suitable way, for example but not limited to, by using a touch input or a voice command.

Following selection of the “yes” option, a two-way audio connection is established between the first and second terminal 11, 12 (this is denoted by the letter “A” in FIG. 3C). This enables the users of the first and second terminals 11, 21 to speak with one another.

As mentioned earlier, the controller 46 is operable to determine a gesture type of touch inputs applied to the touchscreen 40, 42. In FIG. 3B, the touch input is a “knock input”. The controller 46 of the first terminal 11 determines the application if a knock input and in response causes gesture type information indicative of the type of gesture applied to the touchscreen 40, 42 to be included in the command signal which is transmitted to the second terminal 21. Upon receiving the command signal, the controller 46 of the second terminal 21 is operable to determine from the gesture type information contained in the command signal the gesture type of touch input applied to the touchscreen 40, 42 of the first terminal 11. Based on this determination the controller 46 of the second terminal is operable to select the type of alert to be output via the loudspeaker 52 to the user of the second terminal 21. For example, if the gesture type information contained in the command signal indicates that the touch input was a “knock input”, the controller 46 of the second terminal 21 may cause a knocking sound to the output by the loudspeaker 52 of the second terminal 21. Similarly, if the gesture type information indicates that the touch input was a “scratch input” the controller 46 may cause the loudspeaker of the second terminal 21 to output a scratching sound. If the gesture type information indicates that the touch input was a “press input”, the controller 46 of the second terminal 21 may cause the loudspeaker 52 to output a doorbell sound. Many different types of sound may be stored in memory 48 of the second terminal 21, each associated with a different gesture type.

In the example shown in FIG. 3B, the touch input is a “knock input”. As such, the command signal caused by the controller 46 of the first terminal 11 to be transmitted to the second terminal 21 contains gesture type information indicating a “knock input”. Consequently, upon receipt of the command signal, the controller 46 of the second terminal 21 selects and causes to be output by the loudspeaker 52 a knocking sound.

According to some example embodiments, the first terminal 11 comprises a force sensor 44 associated with the touchscreen 40, 42 for allowing the controller 46 to determine a force of the touch input. In such example embodiments, the controller 46 of the first terminal 11 causes force information to be included in the command signal. Upon receiving the command signal containing the force information, the controller 46 of the second terminal 21 may select an output volume for the alert based on the force information. Thus, for example, if the touch input was applied with a relatively large force, the controller 46 of the second terminal 21 may cause the alert to be output with a high volume. Conversely, if the touch input was applied with a relatively small force, the controller 46 of the second terminal 21 may cause the alert to be output with a low volume. The force information may include an identification of a force level of the touch input. For example, if the touch input is applied with a non-zero force below a first threshold, the force information may indicate that the touch input was at a first force level. If the touch input is applied with a force between the first threshold and a second threshold, the force information may indicate that the touch input was at a second force level. Finally, if the touch input is applied with a force above the second threshold, the force information may indicate that the touch input was at a third force level. In response to receiving the indication of the force level, the controller 46 of the second terminal 21 may select a volume level corresponding to the force level. For example, a first volume level may be associated with the first force level, a second volume level, being higher than the first volume level, may be associated with the second force level and a third volume level, being higher than the second volume level, may be associated with the third force level. It will be appreciated that there may be any number of force and corresponding volume levels.

It will be understood that the command signal may include both type information and force information. The provision of type and force information in the command signal further enhances the “virtual window” effect of the system as the first user is able to influence the alert that it output by the second terminal 21, thus giving the impression that the user is actually knocking on a window.

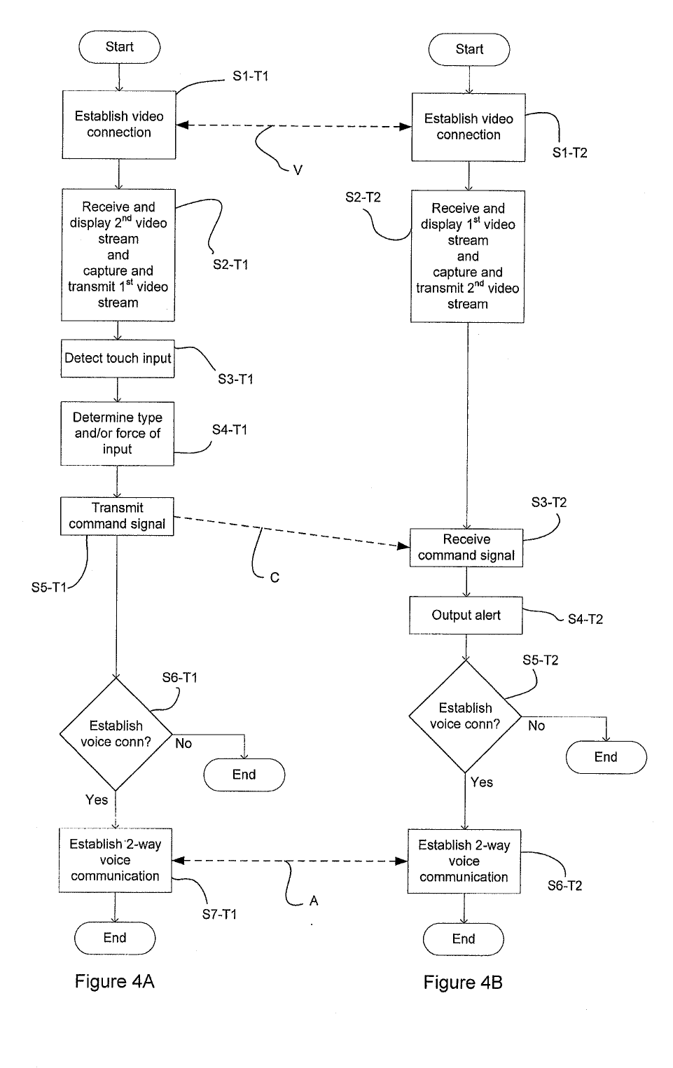

FIGS. 4A and 4B are flowcharts depicting operations of the first and second communication apparatuses 10, 20 respectively according to the first example embodiment of the invention. As the operations of FIGS. 4A and 4B are concurrent, they will be described simultaneously. Signals passing between the first and second communication apparatuses 10, 20 are denoted by dashed arrows interconnecting steps of FIGS. 4A and 4B. The signals are provided with the same denotations as the corresponding signals in FIGS. 3A to 3C. As such, an audio signal is denoted “A”, a video signal is denoted “V”, and a command signal is denoted “C”.

Firstly, in steps S1-T1 and S1-T2 a two-way video connection is established between the first and second communication apparatuses 10, 20 via the network 30.

In step S2-T1, which is concurrent with step S2-T2, the first terminal 11 receives the second video stream from the second communication apparatus 20 and displays the second video stream on the display panel 40. The first terminal 11 captures the first video stream via its camera module 56 and transmits the first video stream via the first transceiver 12 to the second communication apparatus 20.

In S2-T2, the second terminal 21 captures the second video stream via its camera module 56 and transmits it via the second transceiver 22 to the first communication apparatus 10. Additionally, the second terminal 21 receives the first video stream and from the first communication apparatus 10 and displays in on its display panel 40.

In step S3-T1, the controller 46 of the first terminal 11 detects, based on signals received from the touch-sensitive transducer 42, a user input incident on the surface of the touchscreen 40, 42.

Next, in step S4-T1, the controller 46 of the first terminal 11 determines the gesture type of the user input. Additionally or alternatively the controller 46 may also determine, based on signals received from the force sensor 44, a force of the user input.

In step S5-T1, the controller 46 of the first terminal 11 causes a command signal, optionally including force and/or gesture type information to be transmitted, via the network 30, to the second terminal 21.

Subsequently, in step S3-T2 (as shown on FIG. 4B), the second terminal 21 receives the command signal from the first terminal 11. In response to receiving the command signal, the second terminal 21, in step S4-T2, causes an audible alert to be output via the loudspeaker 52. The type and/or the volume of the alert may be selected based upon type and/or force information contained within the command signal.

Next, in step S5-T2, the second terminal 21 determines, for example determined based on a received user input, whether a two-way audio connection between the first and second terminals 11, 21 is to be established.

If in step S5-T2, it is determined that the two-way audio connection is to be established, a signal indicative of this may be transmitted from the second terminal 21 to the first terminal 11 (step not shown on FIG. 4B).

If in step S5-T2, it is determined that a two-way audio connection is not to be established, the method ends. This may be determined, for example, based on receipt of the user input or in response to the absence of a user input within a predetermined duration after the output of the alert. The second terminal 21 may optionally transmit a signal to the first terminal 11 indicating that an audio connection is not to be established (this step is not shown in FIG. 4B).

In step S6-T1, the first terminal 11 determines if an audio connection between the first and second terminals 11, 21 is to be established. This determination may be made based on receipt from the second terminal of an indicative signal. Optionally, the controller 46 of the first terminal 11 may cause a timer to be started in response to sending the command signal to the second terminal 21, and if no signal indicating that an audio connection is to be established is received from the second terminal 21 prior to expiry of the timer, the controller 46 may determine that audio connection is not to be established. Alternatively, the controller 46 of the first terminal 11 may determine that an audio connection is not to be established in response to receiving a signal indicative of such from the second terminal 21.

In response to a negative determination in step S6-T1, the method ends.

In response to a positive determination in step S6-T1, the first and second terminals 11, 21, in steps S7-T1 and S6-T2 respectively, establish a two-way audio connection. The two-way video connection remains active. Subsequent to step S7-T1, the operation of FIG. 4A ends. Likewise, subsequent to step S6-T2 the operation of FIG. 4B ends.

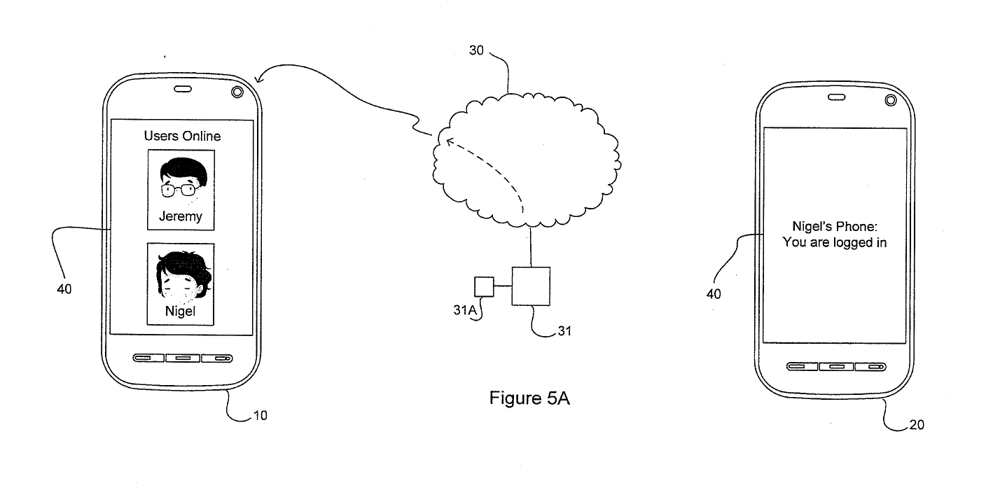

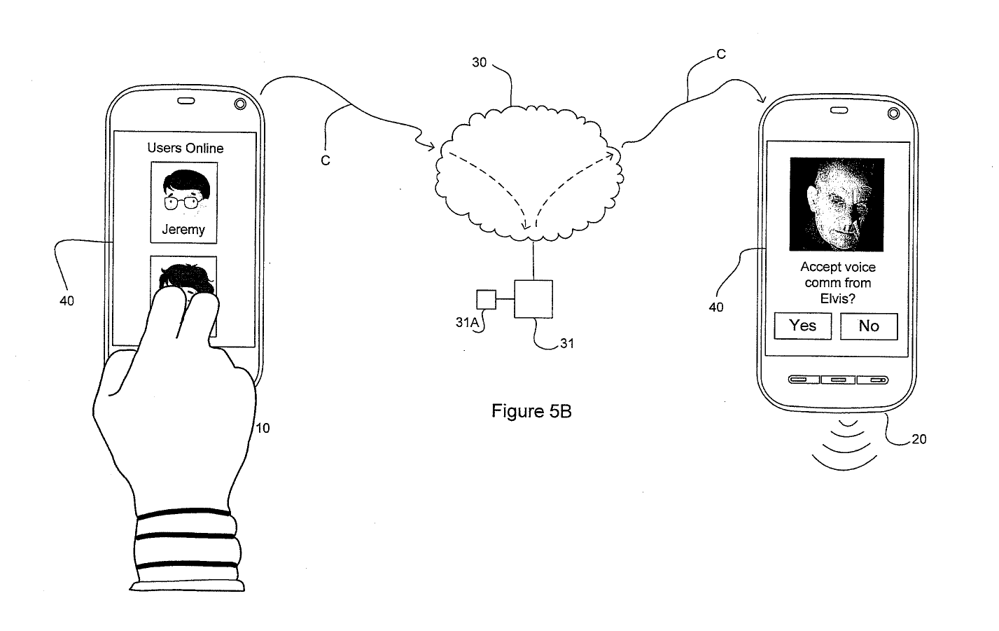

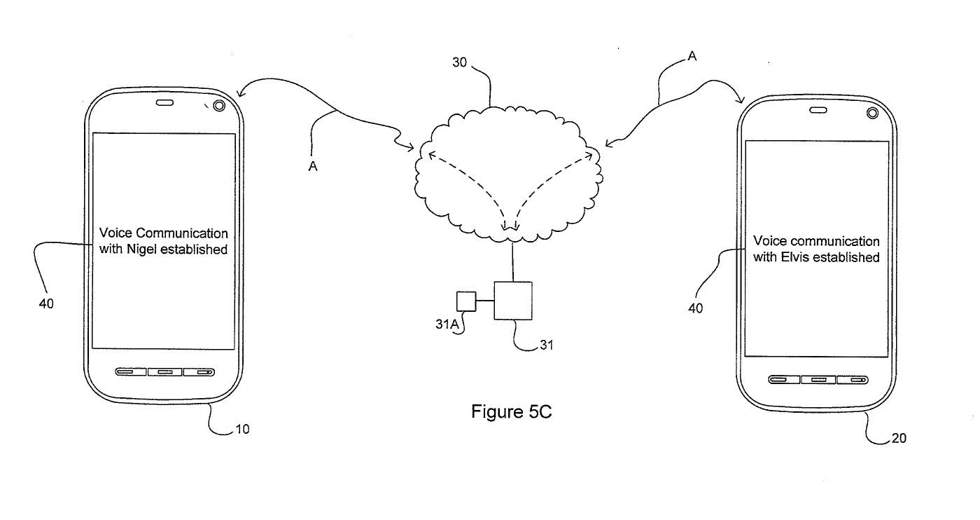

FIGS. 5A to 5C depict an operation according to a second example embodiment of the invention.

In FIG. 5A, the first terminal 11, which in this example happens to be a mobile telephone, is in communication with the server apparatus 31 via the network 30. The first terminal 11 is receiving, from the server apparatus 31, information, including images, relating to users of other communication apparatuses which are also in communication with the server apparatus 31. According to some examples, each of the communication apparatuses which are in communication with the server apparatus 31 may be required to sign in with the server apparatus 31 at the start of the communication session. In this example, the server apparatus 31 is a social networking server.

In FIG. 5A, the first communication apparatus 10 is receiving information, such as an image or images representing other users whose terminals are currently in communication with the server apparatus 31. The image may be an avatar representing the user and thus may include three-dimensional model data representing the user, a two-dimensional icon or picture representing the user or simply username of the user. The information received from the server apparatus is displayed on the display panel 40 of the first terminal 11.

In FIG. 5B, the user of the first terminal 11 decides that they wish to initiate a two-way audio connection session with another of the users currently in communication with the server apparatus 31. Consequently, the user of the first terminal 11 applies a touch input to a region of the display of the first terminal 11 at which an image representing a user with whom they wish to communicate is displayed.

In response to receiving the touch input, the first terminal 11 causes a command signal to be sent to a communication apparatus associated with the selected user, in this case the second terminal 21. The transmittal of the command signal may comprise the first terminal 11 transmitting the command signal to the server apparatus 31 via the network 30, and the server apparatus 31 forwarding the command signal to the second terminal 21. The command signal may include user information identifying the selected user, and the server apparatus 31 may forward the command signal to the second terminal 21 based on the user information.

The command signal transmitted by the first terminal 11 may also include information identifying the user of the terminal from which the command signal originates. Alternatively, the server apparatus 31 may include this information in the command signal prior forwarding to the second terminal 21. This information allows the second terminal to identify the user of the first terminal 11.

As described with reference to the first example embodiment, the command signal transmitted by the first terminal 11 may include gesture type information relating to the gesture type of the touch input received at the first terminal 11 and force information relating to the force of the touch input received at the first terminal 11. In the example of FIG. 5B, the gesture type is a “knock input” and thus the command signal includes information indicative of such.

Next, upon receiving the command signal from the server apparatus 31, the controller 46 of the second terminal 21 causes the loudspeaker 52 to output an alert for alerting the user of the second terminal 21 that initiation of a two-way audio connection is requested. The type of the alert caused to be output by via the loudspeaker 52 is based on the gesture type information included in the command signal. Thus, as the input received at the first terminal is a “knock input”, the controller 46 of the second terminal is operable to cause a knocking sound to be output by the loudspeaker 52. The volume of the alert caused to be output by via the loudspeaker 52 is based on the force information included in the command signal.

In addition to outputting the alert, the controller of the second terminal may also cause an image, received from the server apparatus 31 and representing the user of the first terminal 11, to be displayed on the display panel.

The controller 46 of the second terminal 21 may also cause to be displayed a request for input from a user of the second terminal as to whether a two-way audio connection with the user of the first terminal 11 is to be established. In FIG. 5B, displaying this request includes text being displayed on the screen along with selectable options; one for “yes” and the other for “no”. Thus, if the second user wishes to initiate an audio connection with the first terminal 11 they select the “yes” option and, conversely, if they do not wish to initiate an audio connection with the first terminal 11 they select the “no” option. It will be appreciated that the user may select the “yes” or “no” options in any suitable way, for example but not limited to, by using a touch input or a voice command.

In FIG. 5C, once the user of the second communication apparatus 20 has indicated that they wish to establish a two-way audio connection with the user of the first terminal 11, a two-way audio connection between the first and second terminals 11, 21 is established. According to alternative embodiments a two-way audio-visual connection (i.e. including a video stream) may be established. The two-way audio connection between the first and second terminals 11, 21 may be via the server apparatus 31.

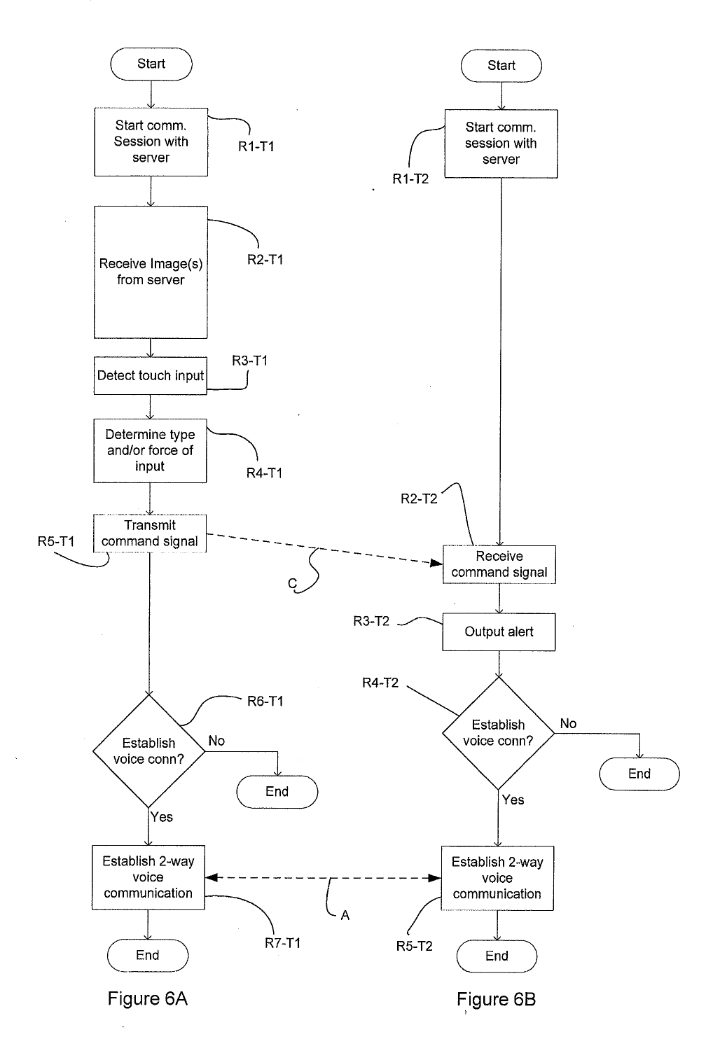

Operations of the first and second communication apparatuses 10, 20 according to the second example embodiment of the invention will now be described with reference to FIGS. 6A and 6B.

FIG. 6A is a flowchart depicting the operation of the first terminal 11 according to the second example embodiment of the invention. FIG. 6B is a flowchart depicting the operation of the second terminal 21 according to the second example embodiment of the invention. FIGS. 6A and 6B will be described simultaneously. Signals passing between the first and second communication apparatuses 10, 20 are denoted by dashed arrows interconnecting steps of FIGS. 6A and 6B. The signals are provided with the same denotations as the corresponding signals in FIGS. 5A to C. As such, an audio signal is denoted “A” and a command signal is denoted “C”.

In step R1-T1 of FIG. 6A the first terminal 11 starts a communication session with the server apparatus 31. In step R1-T2 of FIG. 6B, the second terminal 21 starts a communication session with the server. The starting of a communication session with a server may require a user of the first or second communication devices to log in to or register with the server. This may be done in any suitable way, for example, using a username and a password.

In step R2-T1, the first communication apparatus 10 receives one or more images from the server 31, which may be stored in the store 31A. The received images represent other users which are also currently participating in a communication session with the server. Thus, the images are associated with the users and also with their respective communication apparatuses.

Next, in step R3-T1, the images are displayed on the display panel 40 of the first terminal 11. In some situations, there may be too many images to display on the display panel 40 at one time. In such circumstances, the images may be navigable in any suitable way, for example by scrolling.

In step R4-T1, the controller 46 of the first terminal 11 determines that a user input is incident on the surface of the touchscreen 40, 42. This determination is based on signals received from the touch-sensitive transducer 42. Next, in step R5-T1, the controller 46 determines the identity of the user associated with the image to which the touch input is incident.

In step R4-T1, the controller 46 determines a gesture type of the touch input. Alternatively or additionally, the controller 46 may determine a force of the touch input based on signals received from the force sensor 44.

In step R5-T1, the controller 46 causes a command signal to be transmitted to the server 31. The command signal includes information identifying the user identified by the touch input. The command signal also includes gesture type information and/or force information. The command signal transmitted from the first communication apparatus 10 is forwarded by the server 31 via the network 30 to the second communication apparatus 20. The command signal may contain information identifying the user of the first terminal 11. This user information may be included in the command signal by the first terminal 11 or alternatively may be added to the command signal prior to forwarding by the server 31.

In step R2-T2, the second terminal 21 receives the command signal from the first terminal 11 via the network and also optionally via the server apparatus 31.

In step R3-T2, based on the command signal, the controller 46 of the second terminal 21 causes the loudspeaker 52 to output an alert. The type and volume of the alert may be based on the gesture type information and the force information included in the command signal.

Next, in step R4-T2, the second terminal 21 determines, for example based on a received user input, whether a two-way audio connection between the first and second terminals 11, 21 is to be established.

If, in step R4-T2, it is determined that the two-way audio connection is to be established, a signal indicative of this may be transmitted from the second terminal 21 to the first terminal 11 (step not shown on FIG. 5B).

If, in step R4-T2, it is determined that a two-way audio connection is not to be established, the method ends. This may be determined, for example, based on receipt of the user input or in response to the absence of a user input within a predetermined duration after the output of the alert. The second terminal 21 may optionally transmit a signal to the first terminal 11 indicating that an audio connection is not to be established (this step is not shown in FIG. 4B).

In step R6-T1, the controller 46 of the first terminal 11 determines if an audio connection between the first and second terminals 11, 21 is to be established. This determination may be made based on receipt from the second terminal 21 of an indicative signal. Optionally, the controller 46 of the first terminal 11 may cause a timer to be started in response to sending the command signal to the second terminal 21 and, if no signal indicating that an audio connection is to be established is received from the second terminal 21 prior to expiry of the timer, the controller 46 may determine that audio connection is not to be established. Alternatively, the controller 46 of the first terminal 11 may determine that an audio connection is not to be established in response to receiving a signal indicative of such from the second terminal 21.

In response to a negative determination in step R6-T1, the method ends.

In response to a positive determination in step R6-T1, the first and second terminals 11, 21, in steps R6-T1 and R5-T2 respectively, establish a two-way audio connection. Subsequent to step R6-T1, the operation of FIG. 6A ends. Likewise, subsequent to step R5-T2 the operation of FIG. 6B ends.

The second example embodiment has been described with reference to a social networking server 31. However, it will be understood that the server apparatus may be a different type of server, such a virtual world server. Participants in virtual worlds may control their avatar to roam the virtual world and to interact with avatars of other users. In such examples, a user of a first terminal may apply a touch input to a region of the screen on which avatar of a second user (which is received from the server apparatus 31) is displayed. This causes a command signal to be sent to the communication apparatus associated with the second user. The control signal may include the same information as described with reference to FIGS. 6A and B. The control signal may cause the communication apparatus to output an alert as described above, and a two way audio (or audio-visual connection) may subsequently be established between the first terminal 11 and the communication apparatus of the second user.

Similarly, the server apparatus 31 may be a mapping server. As such, images received at the first terminal from the server apparatus 31 may comprise map images or street level images comprising images of houses, shops, roads etc of a mapped region. The user may move around the mapped region and initiate an audio communication with communication apparatuses of business entities such as shops depicted on the map, by applying a touch input, such as a knock, scratch or press input, to a region of the touch screen on which the premises of the business entity is displayed. As described above with reference to FIGS. 5A to C and 6A and B, in response to the touch input, a command signal for causing an alert to be output is transmitted to the communication of the business entity.

It should be realized that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. Apparatus comprising:
at least one processor; and
at least one memory including computer program code,
where the at least one memory and the computer program code are configured, with the at least one processor, to cause the apparatus at least, during a communication session with remote apparatus:
to cause to be displayed on a display a first image received from the remote apparatus as part of the communication session; and
to be responsive to receipt of a signal indicative of an incidence of a touch input at a location on the display at which the image is displayed to cause to be transmitted to a remote terminal associated with the first image a signal for causing an alert to be output by the remote terminal.

2. The apparatus of claim 1, wherein the at least one memory and the computer program code are configured, with the at least one processor, to cause the apparatus, subsequent to causing transmittal to the remote terminal of the signal, to cause a two-way audio connection with the remote terminal to be established.

3. The apparatus of claim 1, wherein:
the remote terminal comprises the remote apparatus;
the communication session is a video communication session; and
the first image is a portion of an incoming video stream.

4. The apparatus of claim 3, wherein the video communication session comprises a two-way video communication session, and wherein the at least one memory and the computer program code are configured, with the at least one processor, to cause the apparatus to cause an outgoing video stream to be transmitted to the remote terminal.

5. The apparatus of claim 1, wherein the at least one memory and the computer program code are configured, with the at least one processor, to cause the apparatus to receive a signal indicative of a gesture type of the touch input and to cause the signal for causing an alert to be output by the remote terminal to contain information indicative of the gesture type of the touch input.

6. The apparatus of claim 1, wherein the at least one memory and the computer program code are configured, with the at least one processor, to cause the apparatus to receive a signal indicative of a force of the touch input and to cause the signal for causing an alert to be output by the remote terminal to contain information indicative of the force of the touch input.

7. The apparatus of claim 1, wherein the remote apparatus is a server and wherein the at least one memory and the computer program code are configured, with the at least one processor, to cause the apparatus to cause the signal for causing an alert to be output by the remote terminal to be transmitted to the remote terminal via the server.

8. The apparatus of claim 7, wherein the at least one memory and the computer program code are configured, with the at least one processor, to cause the apparatus, subsequent to causing transmittal to the remote terminal of the signal, to cause a two-way audio-visual connection with the remote terminal to be established.

9. A system comprising:
an apparatus comprising:
at least one processor; and
at least one memory including computer program code,
where the at least one memory and the computer program code are configured, with the at least one processor, to cause the apparatus at least, during a communication session with remote apparatus:
to cause to be displayed on a display a first image received from the remote apparatus as part of the communication session; and
to be responsive to receipt of a signal indicative of an incidence of a touch input at a location on the display at which the image is displayed to cause to be transmitted to a remote terminal associated with the first image a signal for causing an alert to be output by the remote terminal; and
a remote terminal, the remote terminal comprising at least one processor and at least one memory including computer program code, where the at least one memory and the computer program code are configured, with the at least one processor, to cause the remote terminal to be responsive to receipt of the signal for causing the alert to be output to cause an audible alert to be output by a loudspeaker.

10. The system of claim 9, wherein the signal for causing the alert to be output includes information indicative of a force of the touch input detected at the apparatus, and wherein the at least one memory of the remote terminal and the computer program code of the remote terminal are configured, with the at least one processor of the remote terminal, to cause the remote terminal to select an output volume for the alert based on the force information.

11. The system of claim 9, wherein the signal for causing the alert to be output includes information indicative of a gesture type of the touch input detected at the apparatus, and wherein the at least one memory of the remote terminal and the computer program code of the remote terminal are configured, with the at least one processor of the remote terminal, to cause the remote terminal to select a type of the alert based on the gesture type information.

12. A method comprising:
during a communication session with a remote apparatus:
causing to be displayed on a display a first image received from the remote apparatus as part of the communication session, and
responding to receipt of a signal indicative of an incidence of a touch input at a location on the display at which the image is displayed by causing to be transmitted to a remote terminal associated with the first image a signal for causing an alert to be output by the remote terminal.

13. The method of claim 12, comprising, subsequent to causing transmittal to the remote terminal of the signal, causing a two-way audio connection with the remote terminal to be established.

14. The method of claim 12, wherein:
the remote terminal comprises the remote apparatus;
the communication session is a video communication session; and
the first image is a portion of an incoming video stream.

15. The method of claim 14, wherein the video communication session comprises a two-way video communication session, and the method comprising causing an outgoing video stream to be transmitted to the remote terminal.

16. The method of claim 12, comprising:
receiving a signal indicative of a gesture type of the touch input; and
causing the signal for causing an alert to be output by the remote terminal to contain information indicative of the gesture type of the touch input.

17. The method of claim 12, comprising:
receiving a signal indicative of a force of the touch input; and
causing the signal for causing an alert to be output by the remote terminal to contain information indicative of the force of the touch input.

18. The method of claim 12, comprising causing the signal for causing an alert to be output by the remote terminal to be transmitted to the remote terminal via the server.

19. The method of claim 18 comprising, subsequent to causing transmittal to the remote terminal of the signal, causing a two-way audio-visual connection with the remote terminal to be established.

20. A non-transitory computer-readable storage medium having stored thereon computer-readable code, which, when executed by computing apparatus, causes the computing apparatus, during a communication session with remote apparatus:
to cause to be displayed on a display a first image received from the remote apparatus as part of the communication session; and
to be responsive to receipt of a signal indicative of an incidence of a touch input at a location on the display at which the image is displayed to cause to be transmitted to a remote terminal associated with the first image a signal for causing an alert to be output by the remote terminal.

21. (canceled)
